(19) United States
(12) Patent Application Publication
(10) Pub. No.: US 2014/0256382 A1
(43) Pub. Date: Sep. 11, 2014

(54) CELLULAR TELEPHONES AND TOUCH SCREEN DISPLAYS HAVING ANTI-MICROBIAL COATINGS

(71) Applicant: Patrick E. Eddy, Allendale, MI (US)

(72) Inventor: Patrick E. Eddy, Allendale, MI (US)

(21) Appl. No.: 14/204,651

(22) Filed: Mar. 11, 2014

Related U.S. Application Data
(60) Provisional application No. 61/776,122, filed on Mar. 11, 2013.

(51) Int. Cl. A01N 25/08; H04M 1/02; A01N 55/00

(52) U.S. Cl. CPC A01N 25/08; A01N 55/00; H04M 1/0266
USPC 455/566; 424/411; 514/63

(57) ABSTRACT

A touch screen and a cellular telephone are provided that may include one or more surfaces coated with an antimicrobial treatment, which may include a silane quaternary ammonium salt and isopropyl alcohol. The silane quaternary ammonium salt may initially include an unreacted organofunctional silane that subsequently reacts with and covalently bonds to the surfaces of the touch screen, such as 3-(trimethoxysilyl) propyldimethyloctadecyl ammonium chloride. Methods are also provided for coating, or otherwise integrating the antimicrobial treatment on or within a touch screen and a cellular telephone.

### CROSS-REFERENCE TO RELATED APPLICATION

This application claims priority under 35 U.S.C. §119(e) upon U.S. Provisional Patent Application No. 61/776,122, entitled “CELLULAR TELEPHONES AND TOUCH SCREEN DISPLAYS HAVING ANTI-MICROBIAL COATINGS” filed on Mar. 11, 2013, by Patrick E. Eddy, the entire disclosure of which is incorporated herein by reference.

### BACKGROUND OF THE INVENTION

The present invention generally relates to touch screen displays, and more particularly relates to touch screens of cellular telephones, laptops, computer monitors, tablets, and other devices or instruments.

Cellular telephones are known to serve as a vehicle for bacteria to spread because they are touched by people's hands and placed near their mouths. U.S. Pat. Nos. 7,645,824 and 7,754,625 propose to add anti-microbial coatings of a zeolite carrier having silver ions and optionally copper ions to cellular telephones. However, the disclosed silver-containing anti-microbial coating materials are electrically conductive and most of them are not transparent. Accordingly, these anti-microbial materials may not be applied to the display of the cellular telephone. This renders the coating only partially useful as many cellular telephones now have touch screens that are used for keypads, and therefore many of the bacteria reside on the screen.

### SUMMARY OF THE INVENTION

According to one embodiment of the present invention, a transparent non-conductive antimicrobial treatment material is applied as a coating over at least one surface of a cellular telephone including a touch screen display. The antimicrobial treatment material is substantially transparent after application and is electrically non-conductive, and wherein the antimicrobial treatment material comprises a silane quaternary ammonium salt.

According to another embodiment of the present invention, a transparent non-conductive antimicrobial treatment material is applied as a coating over at least one external surface of a touch screen display. The antimicrobial treatment material is substantially transparent after application and is electrically non-conductive, and wherein the antimicrobial treatment material comprises a silane quaternary ammonium salt.

According to another embodiment, a method is provided for treating a touch screen display with an antimicrobial treatment solution comprising the steps of: providing an antimicrobial treatment solution comprising isopropyl alcohol and an antimicrobial treatment substance, wherein said antimicrobial treatment substance comprises a silane quaternary ammonium salt; and applying the antimicrobial treatment solution to at least one surface of the touch screen display, wherein the antimicrobial treatment substance is substantially transparent after application and is electrically non-conductive.

In one or more of these embodiments, the silane quaternary ammonium salt may initially have an unreacted organofunctional silane that, after application, reacts with and covalently bonds to the surfaces of the touch screen display/cellular telephone. The silane quaternary ammonium salt may comprise 3-(trimethoxysilyl) propyldimethyloctadecyl ammonium chloride.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is a perspective view of a touch screen display treated in accordance with an embodiment of the present invention;

FIG. 1B is a perspective view of a cellular telephone having a touch screen display treated in accordance with an embodiment of the present invention;

FIG. 2 is a schematic representation of a monomer that may be used in the embodiments described herein as an antimicrobial treatment substance;

FIG. 3 is a schematic representation of a plurality of the monomers shown in FIG. 2 as applied to a treated surface;

FIG. 4A is a schematic representation of the monomer shown in FIGS. 2 and 3 illustrating a first step in the manner by which the monomer destroys a microbe;

FIG. 4B is a schematic representation of the monomer shown in FIGS. 2 and 3 illustrating a second step in the manner by which the monomer destroys a microbe; and

FIG. 4C is a schematic representation of the monomer shown in FIGS. 2 and 3 illustrating a third step in the manner by which the monomer destroys a microbe.

### DETAILED DESCRIPTION OF PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

Aspects of the present invention generally pertain to a touch screen display device comprising a touch screen display. The touch screen display device has a plurality of external surfaces, wherein at least one of the surfaces is coated with an antimicrobial treatment. The antimicrobial treatment may comprise a silane quaternary ammonium salt. The antimicrobial treatment material is substantially transparent after application and is electrically non-conductive.

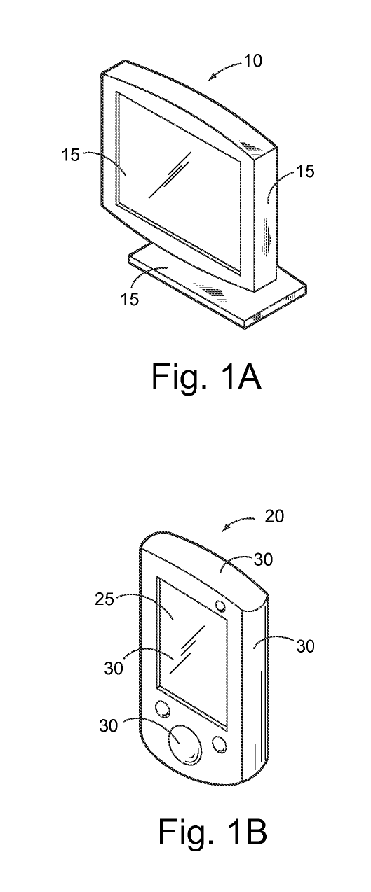

FIG. 1A shows an example of a touch screen display 10 that has one or more of its external surfaces 15 coated with an antimicrobial treatment.

FIG. 1B shows an example of a cellular telephone 20 having a touch screen display 25. Cellular telephone 20 has one or more of its external surfaces 30 coated with an antimicrobial treatment.

In general, the antimicrobial treatment may be applied to all surfaces 15 and 30 of the above touch screen displays 10 and 25 and to the other external surfaces 30 of the cellular telephone 20. However, it is possible to obtain benefits by treating at least some of these surfaces.

The surfaces 15 and 30 are coated with an antimicrobial treatment that may be sprayed onto the surfaces using a solution and/or may be applied using wipes soaked in such a solution. Suitable wipes and solutions are disclosed in commonly-assigned U.S. Pat. No. 8,491,922, the entire disclosure of which is incorporated herein by reference.

In a preferred form, the antimicrobial treatment solution contains 30-50 percent by volume isopropyl alcohol and 50-70 percent by volume antimicrobial treatment substance, which is preferably a silane quaternary ammonium salt having an unreacted organofunctional silane. If the antimicrobial treatment solution is applied by spraying, the solution most preferably includes 50 percent by volume isopropyl alcohol and 50 percent by volume of the unreacted antimicrobial treatment substance. If the solution is applied using the wipes, the solution is preferably 30 percent by volume isopropyl alcohol and 70 percent by volume of the unreacted antimicrobial treatment substance.

The preferred silane quaternary ammonium salt includes an active ingredient of 3-(trimethoxysilyl) propyldimethyloctadecyl ammonium chloride and other inert ingredients. The silane quaternary ammonium salt preferably includes about 0.1 to 50 percent by weight of the 3-(trimethoxysilyl) propyldimethyloctadecyl ammonium chloride and most preferably includes about 5 percent by weight of the 3-(trimethoxysilyl) propyldimethyloctadecyl ammonium chloride. Such silane quaternary ammonium salts are available from Aegis Environments, of Midland, Mich., which is identified as “AEM 5772-5 Antimicrobial,” and from Piedmont Chemical Industries I, LLC of High Point, N.C., which is identified as “PROMOFRESH X 105.” The antimicrobial treatment solution with the isopropyl alcohol is available from MicrobeCare, LLC of Allendale, Mich., under the trademark MICROBECARE™.

The isopropyl alcohol may have a concentration of 70-90 percent. By providing the unreacted organofunctional silane in isopropyl alcohol, the organofunctional silane does not react with the wipe substrates or the inside of the wipe container such that it is free to later react and permanently covalently bond with the surfaces 15/30 of the touch screen display 10/25. Isopropyl alcohol is preferred as it evaporates quickly once the solution is wiped onto the treated surface to allow the unreacted organofunctional silane to more quickly react with the treated surface.

The above described silane quaternary ammonium salt is preferred because it is an organofunctional silane antimicrobial treatment substance that is substantially free from arsenic, silver, tin, heavy metals and polychlorinated phenols; copper; or a silver-ion emitter. In addition, it not only eliminates bacteria on contact, but it remains on the treated surfaces 15 and 30 and kills any bacteria subsequently contacting these surfaces. Such treatment preferably lasts at least one week, more preferably several months, and most preferably indefinitely.

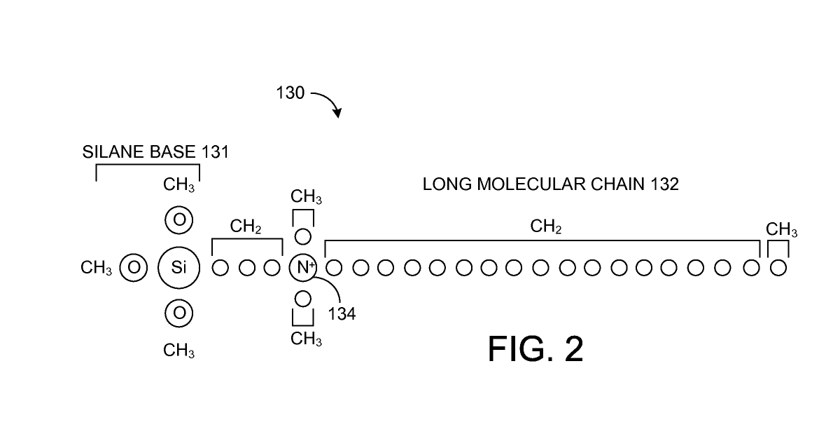

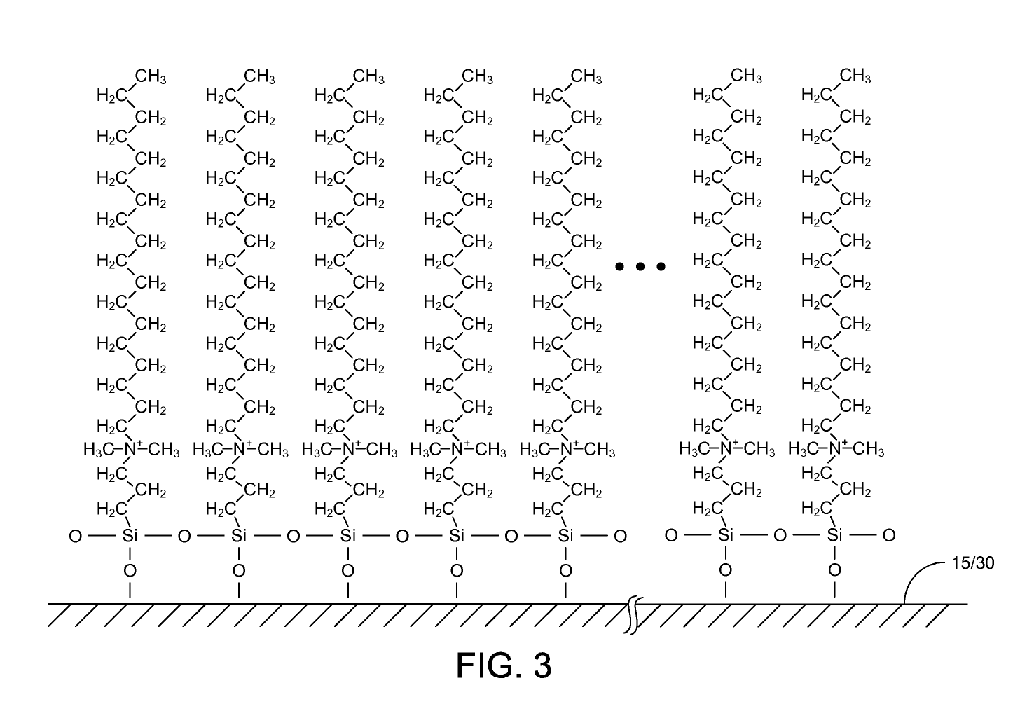

FIG. 2 shows a schematic representation of a monomer form 130 of a preferred organofunctional silane serving as the antimicrobial treatment substance. As illustrated, monomer 130 includes a silane base 131 serving as the unreacted organofunctional silane for bonding to a surface 15/30, a positively charged nitrogen molecule 134, and a long molecular chain 132. As shown in FIG. 3, the silane bases of these monomers react with surfaces 15/30 to covalently and permanently bond to each other and to the surface 15/30 to be treated in such a way that the long molecular chains are aligned and pointing outward from the surface 15/30. This tight bonding provides a micropolymer network that serves as a protective coating on the outside of the surface 15/30 that destroys any microbes that come into contact.

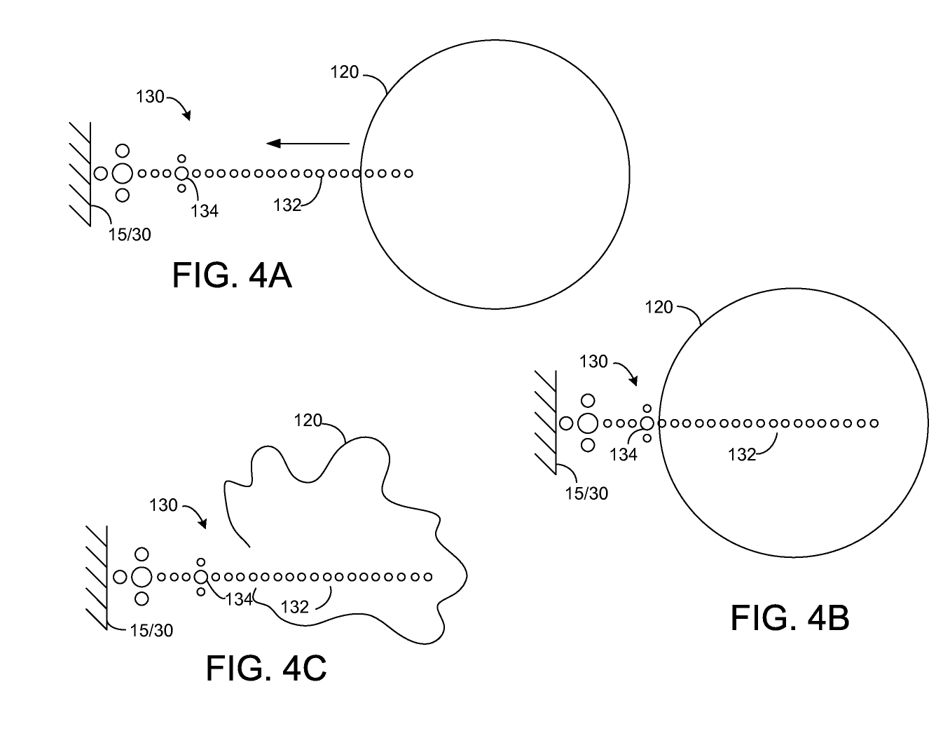

The manner by which the preferred organofunctional silane destroys microbes is illustrated in FIGS. 4A-4C. Such microbes may include bacteria, mold, mildew, algae, etc. As shown in FIG. 4A, the cell membrane 120 of the microbe is attracted to the treated surface 15/30 of the touch screen display 10/25 and then is punctured by the long molecular chain 132 of the monomer 130. As the microbe is drawn closer because of the positive-negative ion exchange, the monomer 130 penetrates further into the cell membrane 120 as shown in FIG. 4B. Once the cell membrane 120 is penetrated deeply, it is physically ruptured by a sword-like action and then electrocuted by the positively charged nitrogen molecule 134 of the monomer 130, thus destroying the microbe as illustrated in FIG. 4C. Thus, the microbes are eliminated without “using up” any of the antimicrobial active ingredients, which remain on the surfaces 15/30 ready to continue protecting the treated item against further microbial contamination.

The preferred organofunctional silane also prevents odor, staining and product deterioration that may be associated with microbe contamination. The preferred organofunctional silane is also beneficial because it permanently bonds to a treated surface, covers a broad spectrum of activity with no negative effects or drawbacks, and is easily incorporated and easily verifiable. Further, the preferred silane quaternary ammonium salt is substantially transparent after application and is electrically non-conductive.

The preferred organofunctional silane is designed to react and create a covalent bond with the surfaces 15/30 of the touch screen display 10/cellular telephone 20. The reacted substance is held onto those surfaces 15/30 until the covalent bond is broken. Tests have shown that most industrial cleaners or disinfectants will not remove the preferred antimicrobial treatment substance. The method of removal is by abrasion.

Although generally described as being used as a display for cellular telephones and computer monitors, the touch screen display 10 described herein may be used on laptops, tablets, and any other electronic device or instrument (particularly those in medical facilities and in shared office environments) that use a touch screen display.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

I claim:

1. A touch screen display device comprising:
a touch screen display having a plurality of external surfaces, wherein at least one of said surfaces is coated with an antimicrobial treatment,
wherein the antimicrobial treatment material is substantially transparent after application and is electrically non-conductive, and
wherein said antimicrobial treatment comprises a silane quaternary ammonium salt.

2. The touch screen display device of claim 1, wherein said silane quaternary ammonium salt includes an organofunctional silane covalently bonded to the at least one surface of the touch screen display.

3. The touch screen display device of claim 1, wherein said silane quaternary ammonium salt comprises 3-(trimethoxysilyl) propyldimethyloctadecyl ammonium chloride.

4. The touch screen display device of claim 1, wherein said antimicrobial treatment is applied to the at least one surface of the touch screen display as an antimicrobial treatment solution comprising said silane quaternary ammonium salt and isopropyl alcohol.

5. The touch screen display device of claim 4, wherein the antimicrobial treatment solution comprises about 30 percent to about 50 percent by volume of isopropyl alcohol at the time of application to the at least one surface.

6. The touch screen display device of claim 4, wherein the antimicrobial treatment solution comprises about 50 percent to about 70 percent by volume of the antimicrobial treatment substance at the time of application to the at least one surface.

7. The touch screen display device of claim 1, wherein said antimicrobial treatment is substantially free from arsenic, silver, tin, heavy metals and polychlorinated phenols.

8. A cellular telephone comprising:
a housing having a plurality of external surfaces; and
a touch screen display disposed in said housing, wherein at least one surface of said touch screen display is coated with an antimicrobial treatment,
wherein the antimicrobial treatment material is substantially transparent after application and is electrically non-conductive, and
wherein said antimicrobial treatment comprises a silane quaternary ammonium salt.

9. The cellular telephone of claim 8, wherein said silane quaternary ammonium salt includes an organofunctional silane covalently bonded to the at least one surface of the touch screen display.

10. The cellular telephone of claim 8, wherein said silane quaternary ammonium salt comprises 3-(trimethoxysilyl) propyldimethyloctadecyl ammonium chloride.

11. The cellular telephone of claim 8, wherein at least one external surface of said housing is coated with the antimicrobial treatment.

12. The cellular telephone of claim 8, wherein said antimicrobial treatment is applied to the at least one surface of the touch screen display as an antimicrobial treatment solution comprising said silane quaternary ammonium salt and isopropyl alcohol.

13. The cellular telephone of claim 12, wherein the antimicrobial treatment solution comprises about 30 percent to about 50 percent by volume of isopropyl alcohol at the time of application to the at least one surface.

14. The cellular telephone of claim 12, wherein the antimicrobial treatment solution comprises about 50 percent to about 70 percent by volume of the antimicrobial treatment substance at the time of application to the at least one surface.

15. A method for treating a touch screen display with an antimicrobial treatment solution comprising the steps of:
providing an antimicrobial treatment solution comprising isopropyl alcohol and an antimicrobial treatment substance, wherein said antimicrobial treatment substance comprises a silane quaternary ammonium salt; and
applying the antimicrobial treatment solution to at least one surface of the touch screen display, wherein the antimicrobial treatment substance is substantially transparent after application and is electrically non-conductive.

16. The method of claim 15, wherein the silane quaternary ammonium salt includes an unreacted organofunctional silane to promote bonding to the at least one surface of the touch screen display, and wherein, upon applying the antimicrobial treatment solution to at least one surface of the touch screen display, said organofunctional silane reacts with and covalently bonds to the at least one surface of the touch screen display.

17. The method of claim 15, wherein the silane quaternary ammonium salt comprises 3-(trimethoxysilyl) propyldimethyloctadecyl ammonium chloride.

18. The method of claim 15, wherein the antimicrobial treatment solution comprises about 30 percent to about 50 percent by volume of isopropyl alcohol at the time of application to the at least one surface.

19. The method of claim 15, wherein the antimicrobial treatment solution comprises about 50 percent to about 70 percent by volume of the antimicrobial treatment substance at the time of application to the at least one surface.

20. The method of claim 15, wherein the touch screen display is integrated within a cellular telephone.
